(19) United States
(12) Patent Application Publication
(10) Pub. No.: US 2023/0236326 A1
(43) Pub. Date: Jul. 27, 2023

(54) SYSTEM AND METHOD FOR DETERMINING A RECEIVER GROUND POSITION

(71) Applicant: ESC AEROSPACE US, INC., Orlando, FL (US)

(72) Inventors: Danny Stirtz, Orlando, FL (US); Lars Weimer, Orlando, FL (US); Cantwell Carson, Pittsburgh, PA (US)

(21) Appl. No.: 18/011,859

(22) PCT Filed: Jun. 15, 2021
(86) PCT No.: PCT/US2021/037443

§ 371 Date: Dec. 21, 2022

Related U.S. Application Data
(60) Provisional application No. 63/044,263, filed on Jun. 25, 2020.

(51) Int. Cl. G01S 19/29

(52) U.S. Cl. CPC G01S 19/29

(57) ABSTRACT

A positioning, navigation and timing solutions for a ground-based device is determined by receiving a satellite RF signal at the ground-based device. It is determined whether the RF signal is from a satellite of interest. A satellite of interest has known data, enabling an estimation of a current location of the satellite. The RF signal frequency of the satellite of interest is used to collect observed Doppler measurements and time of receipt of the RF signal. The position, navigation and timing solution is determined as a function of the observed Doppler measurements, known data regarding the characteristics of the satellite, and predicted Doppler measurements to enable an estimation of the current location of the receiver.

### CROSS REFERENCE TO RELATED APPLICATION

This application claims priority to U.S. Provisional Patent Application No. 63/044,263 filed on Jun. 25, 2020 and titled “SYSTEM AND METHOD FOR DETERMINING A RECEIVER GROUND POSITION,” the contents of which are incorporated herein in its entirety.

### BACKGROUND OF THE INVENTION

The present invention is directed to a system and method for determining positioning, navigation and timing solutions for a ground based receiver, and more particularly, for determining positioning, navigation and timing solutions utilizing information about a signal transmitted by a satellite, and not the information contained within the signal transmitted by the satellite.

It is known in the art to use satellites to determine positioning, navigation and timing (PNT) for ground-based devices. Signals from global positioning systems (GPS) are now the world standard and the backbone for PNT determination for both civilian and military needs. However, these prior art systems are medium earth orbit (“MEO”) based, and while satisfactory, suffer from the shortcomings that natural environments, countermeasures, and challenging terrain can seriously weaken or deny access to the signals upon which these systems are based.

Even before the arrival of GPS, the Naval Navigation Satellite System (NNSS) was available, making use of a constellation of Low Earth Orbit (LEO) satellites. The Doppler shift of these frequencies was used for military and commercial PNT determination. Being at a much lower orbit than GPS satellites, LEO satellites have much higher signal strength and are spread across many frequency bands, making them much more reliable, difficult to interfere with, and enable much better reception in areas where GPS signals are challenged or unavailable.

Commercial and military systems have been developed over the years in an attempt to overcome the shortcomings and meet the ever-growing needs for such location services and infrastructure. However, these systems tend to be large, heavy, require significant power and as a result are expensive. They are ill fitted for mobile applications or for use by the general public.

Accordingly, a system and method which overcome the shortcomings of the prior art is desired.

### SUMMARY OF THE INVENTION

A positioning, navigation and timing solution for a ground-based device is determined by receiving a satellite RF signal at the ground-based device. It is determined whether the RF signal is from a satellite of interest. A satellite of interest has known data, enabling an estimation of a current location of the transmitting satellite. The RF signal frequency of the satellite of interest is used to collect observation information. The location of the satellite of interest is estimated as a function of the time the signal was received and known data for the satellite of interest. Doppler measurements are collected over time as the satellite transmits signals. The position, navigation and timing solution is determined as a function of the observed Doppler measurements, and predicted Doppler measurements to enable an estimation of the current location of the receiver.

### BRIEF DESCRIPTION OF THE DRAWINGS

The features and advantages of the present invention will become more readily apparent from the following detailed description of the invention in which like elements are labeled similarly and in which:

FIG. 1 is an operational diagram of the method for determining PNT in accordance with the invention;

FIG. 2 is a block diagram depicting the physical elements and functions of the invention; and

FIG. 3 is a functional flow diagram of the system for determining PNT in accordance with the invention.

### DETAILED DESCRIPTION OF THE PREFERRED EMBODIMENTS

There are currently thousands of active RF transmitting satellites such as amateur satellites, search and rescue and communications satellites (i.e. Global Star, Iridium, etc.), and the like broadcasting easy-to-detect beacon/downlink signals in known frequency bands, simplifying detection, tracking, and positioning with specialized specifically tuned receivers. Soon, with the launch of mega-constellations (i.e. StarLink, OneWeb, etc.) there will be tens of thousands. The present invention is capable of determining PNT using any type of satellite with a sufficient ground speed to enable Doppler measurements, and does not need to rely on any navigational satellite (GPS, GNNSS).

The position and velocity of any satellite may be parameterized by its Keplerian elements (represented and published in Two Line Element (TLE data)). These elements, together with the Standard General Perturbations orbit model 4 (SGP4 model), can be used to estimate the position of a satellite at any time.

LEO satellites are a robust source that can be used, in accordance with the present invention, for PNT solutions. In addition to the benefits of higher power signals, the larger number of satellites, as compared to GPS and GNSS dedicated satellites, broadcasting beacons or automated downlink transmissions across multiple frequencies can be made use of by implementing the inventive process.

While the prior art required downloading and interpreting the information contained in the satellite signal, as will be seen below the present invention makes use of the fact that the received signal frequency will be Doppler shifted by the high velocity of the satellite. The resulting shift in Doppler measurements, combined with the estimated position of the satellite enables the position of the receiver to be derived, regardless of any message content or code within the transmitting satellite signal.

Reference is now made to FIG. 1 which provides a conceptual representation over time of the operation of Receiver 300 to determine position in accordance with the invention. In a step 101 satellite 800 broadcasts a signal which may be received at the Earth's surface. Satellite 800 moves relative to the Earth and Receiver 300.

If the detected frequency corresponds to a frequency (satellite) of interest, then a Fast Fourier Transformation (FFT) in a step 102 by Receiver 300 is performed to transform the signal from time domain to frequency domain.

In a step 103 Receiver 300 uses a Frequency Masked Triger (FMT) is used to detect an energy spike within an anticipated frequency band. That spike in energy occurs in a specific time and at a specific frequency enabling the Receiver 300 to continuously monitor for signals. It is also known, that in an alternative embodiment, continuously received signals (those without a spike) of interest will be sampled at a specific time periodicity to mimic a spike reading.

In a step 104, a position of Satellite 800 and its relative velocity are estimated from known orbital characteristics of Satellite 800 at the time of observation. The time of observation is the time of the beacon/downlink capture via FMT or the time of observation based on the periodic sampling of the signal. These known orbital characteristics are obtained from a published TLE set data. Using suitable prediction formulas with known orbital characteristics, the position and velocity of Satellite 800, at any point in the past or future, can be estimated. The TLE data is specific to the simplified perturbations models (SGP, SGP4, SGP8 and SDP8). As a result, any algorithm using a TLE as a data source must implement one of the SGP models to correctly compute the state at a time of interest. Alternatively, if the position of the Receiver 300, current time, and estimated position/velocity of satellite 800 are known to be accurate, the orbital characteristics, TLE, may be derived, and may be more accurate than the published TLE.

In a step 105 a predicted set of Doppler measurements is developed by Receiver 300 for Satellite 800 as a function of the current location of Receiver 300 and the information in the TLE files. This process is repeated for a number of observations as a Satellite 800 transits over the position of receiver 300. Accordingly, a number of respective signals/pulses are received and processed.

In a step 106 a new position for Receiver 300 is estimated by fitting the observed Doppler values to predicted Doppler values. It is assumed that the difference between the predicted Doppler value and any observed Doppler value is caused by the change in the position of receiver 300. A current position of Receiver 300 is therefore obtained by fitting an observed Doppler values to the corresponding predicted Doppler's value.

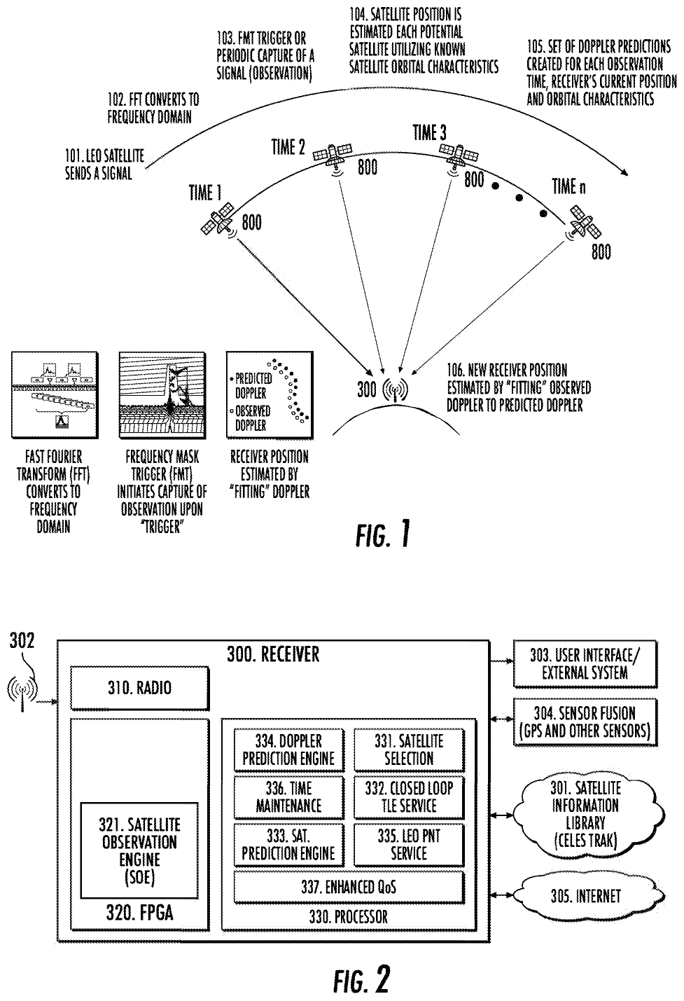

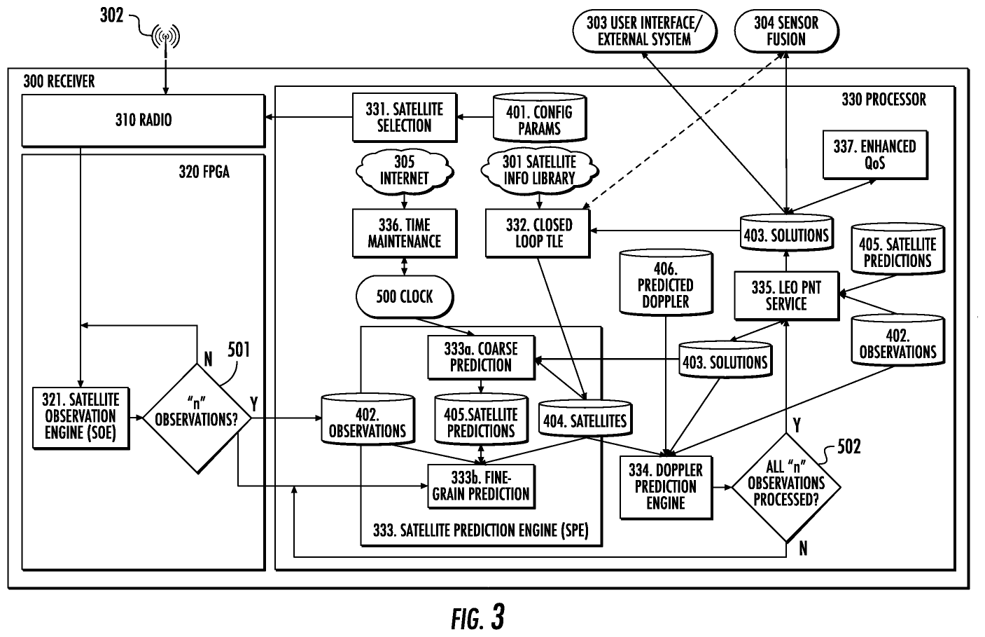

Reference is first made to FIG. 2, in which a block diagram of Receiver 300, constructed in accordance with the invention is provided. Receiver 300 includes an Antenna 302 for receiving the RF satellite signals. Receiver 300 also includes a Field Programmable Gate Array (FPGA) 320 operatively coupled to a Radio 310, and acts as a front-end signal processor for analyzing the RF signals and collecting the observations discussed above. Receiver 300 also includes a Processor 330 that executes application software for converting the received proper signals as output by the FPGA 320 to a PNT solution (position of the Receiver 300).

Receiver 300 may operate as a standalone PNT determination device for operating when GPS signals are totally unavailable, as will be discussed below. Alternatively, it may act as a supplement to conventional GPS receivers and sensors for operating when GPS signals are available. Therefore, in a preferred non limiting embodiment, Receiver 300 includes a Sensor Fusion 304, a receiver capable of receiving a myriad of other location information including GPS. Additionally, Processor 330 may be in communication with a Satellite Information Library 301, located in the cloud; such as Celestrack. A User Interface/External System 303 is shown so that a user or external system may make use of the PNT information as processed by Receiver 300. The Receiver 300 may interface with the Internet 305 to obtain current time as needed.

Radio 310 receives input from the Antenna 302 and providing signal information to the Satellite Observation Engine 321 for processing. Radio 310 is dynamically tuned by the Satellite Selection function 331 to the specific frequencies for all satellites of interest.

Satellite Observation Engine 321 interrogates the RF signals received from the Radio 310. It utilizes Fast Fourier Transforms (“FFT”) and Frequency Masked Triggers (“FMT”) to isolate and identify specific transmissions of interest from a satellite and estimates the time at which the signal is received. If a satellite is not broadcasting a pulsed signal that would enable the FMT to estimate the time the signal is received, Satellite Observation Engine 321 may periodically sample a continuous wave signal and utilize the sample time as the time of signal receipt. Satellite Observation Engine 321 collects each/all observation (frequency and time of receipt) of satellites of interest for processing by the Processor 330.

Continuously throughout operations, the Satellite Selection function 331 will dynamically tune the Radio 310 to the specific frequencies for all satellites of interest enabling reception across all frequencies for all satellites of interest.

A two element set (TLE) of each potential satellite is obtained and that data is stored for use. TLE is a data format including a list of orbital elements of each earth orbiting object for a given point in time; the epoch. It is an estimate of the orbital position as a function of known satellite characteristics at a fixed time. With this data, utilizing a suitable prediction formula, the state (position and velocity) at any point in the past or future for a satellite can be estimated. However, the actual characteristics of any given satellite differ from the published information as a result of orbit decay, repositioning or the like over time. Therefore, this information becomes outdated and is continuously refined by a Closed Loop TLE Service 332 in accordance with the invention, as will be described below. The Closed Loop TLE Service 332 will provide real-time updates for the satellite TLE information. This will improve the accuracy of the satellite location prediction and result in a more accurate receiver location. If internet connectivity is available, TLE information will be downloaded from a “cloud” service, Satellite Information Library 310 such as Celestrak.

A LEO Satellite Prediction Engine 333 receives observation from Satellite Observation Engine 321. In a preferred embodiment, satellite information from an outside source, Satellite Information Library 310 such as Celestrak, is used to determine position of the satellites of interest. Satellite Prediction Engine 333 processes all observations and utilizing saved TLE data in Closed Loop TLE Service 332, estimates the location of all observed satellites for all specific observation times.

Doppler Prediction Engine 334 utilizes the satellite TLE data for each observed satellite and constructs a set of predicted Doppler measurements for all satellites for which signals are received.

A LEO PNT Service 335 utilizes the satellite observations from Satellite Observation Engine 321, Doppler measurements and time of receipt, and the predicted Doppler measurements from Doppler Prediction Engine 334 to derive “position fix” for the receiver unit 300.

An accurate current time is critical to estimation of the position of Receiver 300. A Time Maintenance function 336 will utilize multiple sources of time information to maintain accurate current time.

An Enhanced Quality of Service (QoS) function 337 compares multiple sources of location information to provide overall quality assessment of the derived PNT solution from LEO PNT Service 335.

Reference is now made to FIG. 3, which is a representative functional/ data flow diagram provided to describe the process with greater particularity. Like numerals are utilized to indicate like structure, and for ease of illustration, some structure appears more than once to illustrate its functional relationship with other structure.

At a system startup the Satellite Selection function 331 performs any necessary startup functions including setting of any developer/user definable parameters. These initial parameters are stored in a Config Params data store 401. By way of non-limiting example, these parameters include the radio settings used to tune the Radio 310 to specific frequencies to be processed for the satellites of interest, and other developer/user defined parameters.

Satellite Observation Engine 321 receives RF signals from the Radio 310 as discussed above, and captures observations (frequencies and time of receipt). This is accomplished through the use of FFT and FMT operations to isolate and identify a specific pulse transmission of interest from a satellite of interest. If the satellite is not broadcasting a pulse, the signal may be sampled at a defined periodicity, where observation is the frequency of the signal at the time of the sample.

As discussed above, Satellite Observation Engine 321 performs the function of observation collection until it is determined at a gate 501 that “n” observations are received. Once the “n” observations are processed, these observations are stored in the observation repository 402 and Satellite Prediction Engine 333 is notified. As discussed above, Satellite Prediction Engine 333 and Doppler Prediction Engine 334 will process all of the “n” observations to create a set of predicted satellite positions and predicted Doppler measurements. Once the processing of all “n” observations is complete, LEO PNT Service 335 derives a new position for Receiver 300 as a function of Doppler measurements and time of receipt, and the predicted Doppler measurements.

More specifically, the Satellite Prediction Engine 333 utilizes the current estimated receiver location, stored in a Solutions data store 403, and satellite orbital characteristics, stored in Satellites data store 404, to derive a satellite's estimated location at each time of observation. The information stored in Satellite data store 404 includes TLE information stored therein. The satellite locations, as determined by Satellite Prediction Engine 333, are stored in a Satellite Predictions data store 405.

In a preferred embodiment of the invention Satellite Prediction Engine 333 determines satellite position in two parallel processes. This minimizes processing requirements. The Satellite Prediction Engine 333 performs a Coarse Prediction process 333a as a function of a current time input from the Clock 500, the satellite orbital characteristics stored in Satellite data store 404 and an input from Solution data store 403 to create satellite predictions. This Coarse Prediction function 333a utilizes current time from the Clock 500 to select the other data to estimate which satellites of interest may be in view to Receiver 300 during a time around the anticipated operations. The created satellite predictions are stored in Satellite Predictions store 405.

In parallel, Satellite Prediction Engine 333 performs Fine-grain Prediction functionality 333b. Fine-grain Prediction processing 333b predicts satellite position in response to (i) observations stored in Observation repository 402, (ii) Satellite Predictions store 405, determined by the Coarse Prediction process 333a, and the (iii) data stored in Satellites data store 404. In this way, Fine-grain Prediction processing 333b only provides satellite location predictions for satellites already identified during Coarse Prediction process 333a. The Fine-grain Prediction process 333b narrows down the process to the identity of the most likely satellite of interest, narrowing the data to be retrieved from each data source during processing.

Doppler Prediction Engine 334 utilizes satellite orbital characteristics stored in Satellite data store 404, satellite observations from Observations repository 402 and the current estimated location of the Receiver 300 stored in Solutions data store 403 to calculate the set of predicted Doppler measurements and stores them in Predicted Doppler data store 406.

Doppler Prediction Engine 334 operates on all observations output by Satellite Observation Engine 321 and stored in Observation repository 402. Doppler Prediction Engine 334 utilizes the current location of Receiver 300 from Solutions data store 403, and satellite orbital characteristics from Satellites data store 404 to derive a set of predicted Doppler measurements for each satellite of interest and stores predicted Doppler measurements in Predicted Doppler data store 406. Once all “n” observations are processed as determined by gate 502, LEO PNT Service 335 operates.

LEO PNT Service 335 obtains satellite observation data from the Observation repository 402, satellite prediction data from Satellite Predictions store 405, and the predicted Doppler measurements stored in Predicted Doppler data store 406. LEO PNT Service 335 utilizes the set of predicted Doppler measurements to compare with the observed Doppler measurements. The observed Doppler measured values are derived as a function of the observed frequency from the Observation repository 402 and the base frequency of the satellite of interest. An analysis is performed to fit the predicted Doppler measurements to the observed Doppler measurements. The result of the analysis is an estimation of the Receiver 300's current position which is then stored in the Solutions data store 403.

As discussed above, an initial source for the TLE data may, in a preferred nonlimiting embodiment, be an on-line publicly available source Satellite Information Library 301 such as Celestrak, available at www.Celestrak.space. TLE data is time sensitive. Celestrak updates the TLE data based on actual observations from a fixed position source. This is performed approximately once per day in order to maintain accurate TLE data. Therefore, data should be downloaded at least once a day for the most recent TLE data to maintain the ability to accurately predict a satellite state at a specific time. Again, what becomes readily apparent is that such an ability degrades over time; the claimed invention adjusts for that degradation to provide accurate position location.

Alternatively to downloading the TLE data from Satellite Information Library 301, accurate TLE data may be derived. As part of the derivation process of the present invention, Satellite Prediction Engine 333 will predict satellite locations as a function of time, receiver estimated position and satellite characteristics (TLE). This is based on the current time from Clock 500, the satellites data stored in the Satellites data store 404, and the current position of Receiver 300 previously determined by LEO PNT Service 335 stored in Solutions data store 403. If the position of Receiver 300 is known to be accurate (through the fusion of other positioning sources), then it can be assumed that the satellite predictions generated by Satellite Prediction Engine 333 are also accurate and the system may solve for orbital characteristics of a satellite LTE as a function of the known receiver position, time and accurate predicted satellite locations.

The Closed Loop TLE Service 332 will continuously monitor the quality of the stored TLEs. TLE quality will be derived as a function of time since the last TLE update and the source of the update (Celestrak or other third-party source Satellite Information Library 301). The TLE quality measure will also be used in derivation of a quality measure for the resulting receiver position calculation. Closed Loop TLE Service 332 will determine the most appropriate source of TLE data (downloadable or derived) and update that information in the Satellites data store 404. Alternatively, this real-time TLE data may be uploaded to a cloud instance of the Satellites data store 404 for potential use by other receivers so that a network is updated as a whole with the most accurate TLE data.

The inventive process relies on accurate current time from a Clock 500 as the position of the satellite is determined in four dimensions and the present invention determines the position of Receiver 300 relative to a Satellite 800 at a given point in time. Therefore, a Time Maintenance function 336 is provided for maintaining accurate current time in Clock 500. A variety of sources are utilized by Time Maintenance function 336 to maintain the most accurate current time possible in given situations. By way of non-limiting example, the present invention may be a supplement to GPS location. Therefore, when there is an input from Sensor Fusion 304 indicative of GPS, the GPS signal will be utilized to update the time. Where GPS signals are not available and Receiver 300 communicates with the Internet 305 where current time may be derived from an Internet source. When neither GPS signal or an Internet input are available then current time is maintained through the use of embedded system clock.

An Enhanced Quality of Service (QoS) function 337 compares multiple sources of location information such as LEO satellite signals, GPS signals, other sensors (when available) such as alternators and inertial measurement units to provide overall quality measurement to the user. This quality measurement may also include an indication of potential GPS jamming/spoofing attack. As a result, the Receiver 300, constructed in accordance with the invention, does not totally rely on any one given source of information for the derivation of an accurate PNT.

The inventive process provides accurate location of the Receiver 300 where conventional methodologies such as GPS cannot. This is accomplished through the use of sensor fusion techniques to leverage information from a variety of sources, such as GPS signals when available, altimeters, temperature sensors or the like, and internal measurement unit data. For example, use of altitude information from the barometer/altimeter will greatly improve the positional accuracy of the LEO based solution, which relies on satellite signals alone.

As a result of the inventive techniques described herein a receiver takes advantage of satellite signals in a way that has greater accuracy and is more robust than prior art methods. By making use of the existence of the signal and the frequency of the signal, rather than the content of the signal almost any satellite that exhibits Doppler may be used to determine position. By using LEO satellites the chance that the signal will be robust enough for detection is greatly improved, however the technique can be used on any satellite of interest orbiting the Earth with some tuning of Receiver 300 and potentially modifying or adding an additional antenna. Lastly, utilizing LEO satellite signals as described also minimizes the potential for attack because of the signal strength (as compared to GPS), no reliance on the content of the data embedded within the signal, the number of satellites and the potential wide range of broadcast frequencies of these satellites. In summary, unlike the prior art products, the above described inventive solution does NOT rely on signal and is NOT reliant on costly, sometimes dedicated, receivers/services (i.e. Global Star, Iridium)

It will thus be seen that the objects set forth above, among those made apparent from the preceding description, are efficiently attained and, since certain changes may be made in carrying out the above method and in the construction set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall there between.

What is claimed is:

1. A method for determining positioning, navigation and timing solutions for a ground-based device comprising the steps of:
receiving a satellite RF signal at the ground-based device; the RF signal exhibiting a Doppler effect;
determining whether the RF signal is from a satellite of interest, a satellite of interest having known data enabling an estimation of a current position of the satellite;
utilizing a received RF signal of the satellite of interest to collect observed Doppler measurements of the received RF signal and time of receipt of the RF signal;
estimating the position of the satellite of interest as a function of the known data for the satellite of interest and predicting Doppler measurements for the satellite of interest as a function of the known data; and
determining the position, navigation and timing solution for the ground based device as a function of the observed Doppler measurements, and predicted Doppler measurements to enable an estimation of the current location of the receiver.

2. The method of claim 1, wherein a relative velocity of the satellite of interest is estimated from the known data for the satellite of interest.

3. The method of claim 2, wherein the known data for the satellite of interest includes two line element data.

4. The method of claim 1, further comprising developing a predicted set of Doppler measurements as a function of current location of the ground based device and the known information.

5. The method of claim 1, further comprising the step of providing a clock, the clock outputting a current time, and the method further comprising selecting data to estimate which satellites of interest may be in view to the receiver at the current time.

6. The method of claim 3, further comprising the step of periodically updating the known data.

7. A ground based device having a system for determining a positioning, navigation and timing solution, the system comprising;
a satellite observation engine receiving RF signals from a satellite of interest and isolating and identifying one or more transmissions of interest therefrom as observations;
a closed loop service stores known satellite information regarding the satellite of interest;
a Doppler prediction engine utilizes the satellite information stored in the closed loop service for each observed satellite and constructs a set of predicted Doppler measurements for satellites from which signals are received; and
a LEO PNT service receiving the observations from the satellite observation engine, Doppler measurements and time of receipt, and the predicted Doppler measurements from the Doppler prediction engine and determining a position fix for the receiver.

8. The ground based device of claim 7, further comprising a closed loop service storing the known satellite information about the satellite of interest.

9. The ground based device of claim 7, where in the known information is two line element information.

10. The ground based device of claim 8, wherein the closed loop service receives updated information from a remote source and updates the known satellite information as a function thereof.

11. The ground based device of claim 7, further comprising a satellite selection function tuning the system to the specific frequencies for one or more satellites of interest.

12. The ground based device of claim 7, further comprising a LEO satellite prediction engine receiving observations from the satellite observation engine and satellite information form an outside source and determines a position of the satellite of interest.

13. The ground based device of claim 12, further comprising a closed loop service storing the known satellite information about the satellite of interest, and wherein the Doppler prediction engine receives the known information from the closed loop service, and constructs a set of predicated Doppler measurements for all satellites for which signals are received.
